(19) United States
(12) Patent Application Publication
(10) Pub. No.: US 2025/0118810 A1
(43) Pub. Date: Apr. 10, 2025

(54) THERMOELECTROCHEMICAL OSCILLATOR

(71) Applicants: CLEMSON UNIVERSITY, CLEMSON, SC (US); Indian Institute of Science, Bangalore (IN)

(72) Inventors: Apparao M. Rao, CLEMSON, SC (US); Basanta Ghimire, CLEMSON, SC (US); Mihir Parekh, CLEMSON, SC (US); Nawraj Sapkota, CLEMSON, SC (US); Morteza Sabet, CLEMSON, SC (US); Herbert Behlow, CLEMSON, SC (US); Sriparna Bhattacharya, CLEMSON, SC (US); Abha Misra, BANGALORE (IN); Pankaj Singh Chauhan, BANGALORE (IN)

(21) Appl. No.: 18/906,700

(22) Filed: Oct. 4, 2024

Related U.S. Application Data
(60) Provisional application No. 63/588,149, filed on Oct. 5, 2023.

(51) Int. Cl. H01M 10/26; H01M 4/02; H01M 4/66; H01M 14/00; H01M 50/429

(52) U.S. Cl. CPC H01M 10/26; H01M 4/661; H01M 4/663; H01M 14/00; H01M 50/4295; H01M 2004/027; H01M 2300/0005

(57) ABSTRACT

Described herein are thermoelectrochemical cells which have high Seebeck coefficients, as well as various implementations for said thermoelectrochemical cells. For instance, in some embodiments, the presently described thermoelectrochemical cell may be used to convert low grade heat into electrical energy. In some embodiments, the output electrical energy may have an oscillatory nature. The magnitude of the output energy and the characteristics of the oscillations may be tuned by adjusting electrode pore sizes, thermoelectrochemical cell temperature gradient and the material of at least one of the electrode, electrolyte and separator.

### CROSS REFERENCE TO RELATED APPLICATION

This application claims filing benefit of U.S. Provisional Patent Application Ser. No. 63/588,149 having a filing date of Oct. 5, 2023, which is incorporated herein by reference for all purposes.

### BACKGROUND

Increasing greenhouse gas emissions and global warming have led to a tectonic shift in the ways of generating electricity. While the prudent shift from fossil fuel-based power plants to renewable energy is expected to decrease greenhouse gas emissions, harvesting waste heat adds another dimension to our efforts toward combating climate change. For every 3 J of primary energy, nearly 2 J are lost as waste heat. Conventional methods of electricity generation, such as thermal/nuclear power plants, often generate high-grade waste heat, which could be harvested using electronic thermoelectric materials, although not with desired efficiencies. However, alternative methods such as solar photovoltaics and wind energy lead to ultra-low grade waste heat generation, which could be harvested using ionic thermoelectric devices based on their redox reactions or the Soret effect. Thermogalvanic cells based on redox reactions utilize temperature-dependent entropy difference (and thus, voltage difference) to drive electrochemical reactions at the electrodes in opposite directions. For example, if an aqueous solution containing ferricyanide/ferrocyanide redox couple is used as the electrolyte, the redox reaction proceeds in opposite directions on hot and cold electrodes due to temperature-dependent entropy difference and reaction Gibb's free energy, which drive the electrochemical reactions. The Soret effect utilizes thermophoretic mobility differences between oppositely charged ions to generate a charge separation within the cell, thus leading to voltage generation. Among the ionic thermoelectric devices, some devices utilized the Soret effect and demonstrated a Seebeck coefficient of 24 mV K⁻¹ at room temperature—one of the highest Seebeck coefficients reported to date.

Ultra-low grade waste heat harvesting could not yet be realized because neither ionic nor electronic thermoelectric devices exhibited sufficiently high Seebeck coefficient.

Simultaneously, the internet of things (IoT) has seen increased demand for wearable devices and smart micro devices. Such devices, in the case of wearables, are often worn directly, or closely, to the skin of the user. For instance, some such wearable devices include, but are not limited to, smart watches, smart glasses, ear wear, and body wear. In order to power such devices, the art has typically relied upon battery powered devices. A shortcoming of battery powered devices is that they require frequent charging.

### SUMMARY

According to some embodiments of the present disclosure, described herein are methods for making a thermoelectrochemical cell. For instance, such a thermoelectrochemical cell may be described as comprising a housing, wherein the housing comprises a hot side and a cold side, first and second electrodes, wherein the first and second electrodes may comprise porous electrodes, an electrolyte, wherein the electrolyte is dispersed throughout the cell, and a separator, wherein the separator is disposed between the first and second electrodes and wherein the housing encloses a part of the first and second electrodes, the electrolyte and the separator.

Additionally described herein are pairings between the previously mentioned thermoelectrochemical cell and a load that may be powered by said thermoelectrochemical cell. For instance, an electric device may comprise a power source wherein the power source comprises a housing, wherein the housing comprises a hot side and a cold side, first and second electrodes, wherein the first and second electrodes may comprise porous electrodes, an electrolyte, wherein the electrolyte is dispersed throughout the cell, and a separator, wherein the separator is disposed between the first and second electrodes, wherein the housing encloses a part of the first and second electrodes, the electrolyte and the separator, and a load, which is oscillatory in electric demand.

### BRIEF DESCRIPTION OF THE FIGURES

A full and enabling disclosure of the present subject matter, including the best mode thereof to one of ordinary skill in the art, is set forth more particularly in the remainder of the specification, including reference to the accompanying figures in which:

FIG. 1 is a diagram showing the general construction of a thermoelectrochemical cell as described herein.

FIG. 2 is an SEM photograph of a cellulose separator taken from a perspective perpendicular to the grain of the cellulose fibers.

FIG. 3 is an SEM photograph of a cellulose separator taken from a perspective in-line with the grain of the cellulose fibers.

FIG. 4 is a graph showing the distribution of pores in the CD1 type electrode having a half pore width of specified length measured in angstroms. Additionally, FIG. 4 depicts an inset of the porous structure of a CD1 type electrode via an SEM photograph.

FIG. 5 is a graph showing the distribution of pores in the CD2 type electrode having a half pore width of specified length measured in angstroms. Additionally, FIG. 5 depicts an inset of the porous structure of the CD2 electrode type via an SEM photograph.

FIG. 6 is a graph showing the distribution of pores in the bucky paper type electrode having a half pore width of specified length measured in angstroms. Additionally, FIG. 6 depicts an inset of the porous structure of the bucky paper electrode via an SEM photograph.

FIG. 7 is an analogous circuit diagram for the thermoelectrochemical cell as described herein.

FIGS. 8A-8C are voltage-time graphs for the open circuit voltage of the CD1, CD2 and bucky paper type thermoelectrochemical cells obtained for a temperature difference of 10 K across the thermoelectrochemical cell

FIGS. 9A-9C are voltage-time graphs for the CD1 electrode type thermoelectrochemical cell during constant current discharge (while maintaining a temperature difference of 10 K across the thermoelectrochemical cell) as described herein. Furthermore, each of FIGS. 9A-9C have insets showing magnified traces of voltage vs time.

FIGS. 10A-10D are fast Fourier transforms taken from the insets of FIGS. 9A-9B.

FIGS. 11A and 11B are a continuation of FIGS. 10A-10D. FIGS. 11A-11B depict the fast Fourier transforms shown in insets V and VI in FIG. 9C.

FIG. 12 is a voltage-time graph of CD1 type electrode thermoelectrochemical cell as described herein being discharged with a current of 500 nanoamperes without the application of a thermal gradient to the thermoelectrochemical cell.

FIG. 13 is a voltage-time graph showing the charging of a thermoelectrochemical cell which comprises bucky paper electrodes and an electrolyte of 1M TEABF₄ in acetonitrile and a Celgard polypropylene separator at 100 nanoamperes without the application of a thermal gradient across the cell.

FIG. 14 is a voltage-time graph of a thermoelectrochemical cell comprising bucky paper electrodes, cellulose as the separator, and an aqueous electrolyte comprising sodium chlorite and polyethylene oxide, all under a 250 nanoampere discharge current (while maintaining a temperature difference of 10 K across the thermoelectrochemical cell).

FIG. 15 is a voltage-time graph for a thermoelectrochemical cell comprising CD2 type electrodes without an applied thermal gradient, being discharged at a current of 5 nanoamperes.

FIG. 16 is a voltage-time graph for a thermoelectrochemical cell comprising non-porous steel electrodes when discharged at 5 nanoamperes.

FIG. 17 is a diagram showing a potential cycle which may be employed for using the thermoelectrochemical cell in continuous operation.

FIG. 18 is a voltage-time graph showing the voltage traces when the thermoelectrochemical cell is operated in accordance with the diagram shown in FIG. 17.

FIG. 19 is a schematic of one potential configuration for using the presently described thermoelectrochemical cells in series.

### DETAILED DESCRIPTION

Reference will now be made in detail to various embodiments of the disclosed subject matter, one or more examples of which are set forth below. Each embodiment is provided by way of explanation of the subject matter, not limitation thereof. In fact, it will be apparent to those skilled in the art that various modifications and variations may be made in the present disclosure without departing from the scope or spirit of the subject matter. For instance, features illustrated or described as part of one embodiment, may be used in another embodiment to yield a still further embodiment.

The Seebeck coefficient is a useful metric for determining the magnitude of potential which is created through a temperature gradient as an intensive property of a thermoelectrochemical cell. For instance, the Seebeck coefficient of a thermoelectrochemical cell is generally in units of potential difference per unit of temperature. Thus, for higher Seebeck coefficients, the thermoelectrochemical cell may produce a higher voltage. If higher voltage is produced by the thermoelectrochemical cell, devices requiring higher voltages may be powered by the thermoelectrochemical cell. Additionally, increasing the Seebeck coefficient may lead to better ability to convert waste heat to usable electrical energy.

Without wishing to be limited by any particular theory, the presently described thermoelectrochemical oscillator makes use of the Soret effect. The Soret effect is the tendency of different particles to self-segregate, due to differences in thermophoretic mobilities, when placed into a temperature gradient. For instance, when in use with a thermoelectrochemical cell as described herein, the positive ions of the dissolved electrolyte may have a higher concentration at the hot electrode, whereas negative ions of the dissolved electrolyte may have a higher concentration at the cold electrode. Thus, the Soret effect creates a concentration gradient with respect to charged ions. The Soret effect can therefore be used to harvest energy from temperature differentials.

Without wishing to be limited by any particular theory, the presently described thermoelectrochemical cell makes use of Fick's diffusion. Fick's diffusion is the process by which particles of one type tend to diffuse under concentration gradients to achieve a uniform concentration across all available space. Thus, the process of Fick's diffusion and the Soret effect can be present at the same time, as each process may be driven by different physical phenomena.

At least one surprising finding by the present inventors of the presently described thermoelectrochemical cell is that the voltage output under discharge or charging may be oscillatory. For instance, the present inventors have found that under certain conditions, while the voltage of a thermoelectrochemical cell may generally decrease while it is being discharged, there are increases in voltage from time to time.

In general, the present disclosure is directed to thermoelectrochemical cells which may be used as generators and devices which incorporate said generators. As will be understood by one of skill in the art, the presently described generators allow for a broad swatch of devices to be powered, with or without battery supplementation.

Further, in some embodiments, the presently described devices may be useful for supplying power to devices which have a load that is oscillatory in demand. That is, for devices which require at least one of an oscillating voltage or current, the presently described devices may be used in place of, or along with, traditional batteries or other traditionally used power sources.

The thermoelectrochemical devices described herein generally comprise a housing comprising a hot side and a cold side, a first and a second electrode, an electrolyte and a separator.

In some embodiments, the housing may comprise a coin cell type housing. As a non-limiting example, the coin cell housing format may be useful for insertion into sensors requiring small form factors, or small integral areas. For instance, a plurality of coin cell housings, each containing a thermoelectrochemical cell as described herein, may be employed to power a single device. Said arrangement may allow for increased flexibility, in particular over a single thermoelectrochemical cell having the same effective area as the plurality of coin cell thermoelectrochemical cells.

In some embodiments, the housing of the thermoelectrochemical cell as described herein may comprise various form factors as is known in the art, such as, but not limited to, a pouch, or a cylinder.

In some embodiments of the present disclosure, the housing may be flexible. As a non-limiting example, the housing may be a thin sheet of material which can effectively house and separate the first and second electrodes, as well as the electrolyte and separator. In such embodiments, the thermoelectrochemical cell may be employed within, as a non-limiting example, arm bands. Generally, however, when the housing comprises a flexible material, the thermoelectrochemical cell may readily be used on any desirable surface. As stated above, the housing may comprise a hot side and a cold side. Without wishing to be limited to any particular definition of hot and cold, as used herein, the terms hot and cold are used to refer to relative temperatures. For instance, the hot side of the housing may be greater than 2 degrees Celsius higher in temperature than the cold side, such as greater than 5 degrees Celsius, such as greater than 7 degrees Celsius, such as greater than 10 degrees Celsius. For instance, the hot side may be higher in temperature by 5 to 10 degrees Celsius.

In some embodiments, the size of the housing and/or electrodes may vary. For instance, when higher current is needed, the size of the housing and/or the electrodes may be increased.

In some embodiments, the first and second electrodes may comprise the same material and may be porous or non-porous. For instance, the first and second electrodes may comprise anodized aluminum oxide. However, in some embodiments, the first and second electrodes may comprise different materials. As a non-limiting example, the first and second electrodes may comprise aluminum and copper respectively. Generally, however, the first and second electrodes may comprise a material which is commonly used as an electrode material, such as, but not limited to, iron, manganese, cobalt, carbon, aluminum, copper, stainless steel, silver, nickel, titanium, zinc, sulfur, or alloys, oxides, sulfides, nitrides thereof or mixtures thereof. In some embodiments, the electrodes may comprise conducting polymeric materials such as polyaniline, polypyridine, polyacrylonitrile, their composites with metallic nanoparticles, or mixtures thereof. In some embodiments, the electrodes may comprise 2D materials such as graphene and its derivatives, MXenes, metal organic frameworks (MOFs), covalent organic framework (COFs) or derivations thereof. Further, one electrode may be adjacent to the one side of the housing, e.g., the hot or cold side of the housing. Thus, as with the housing, the first and second electrodes may comprise a hot side electrode and a cold side electrode.

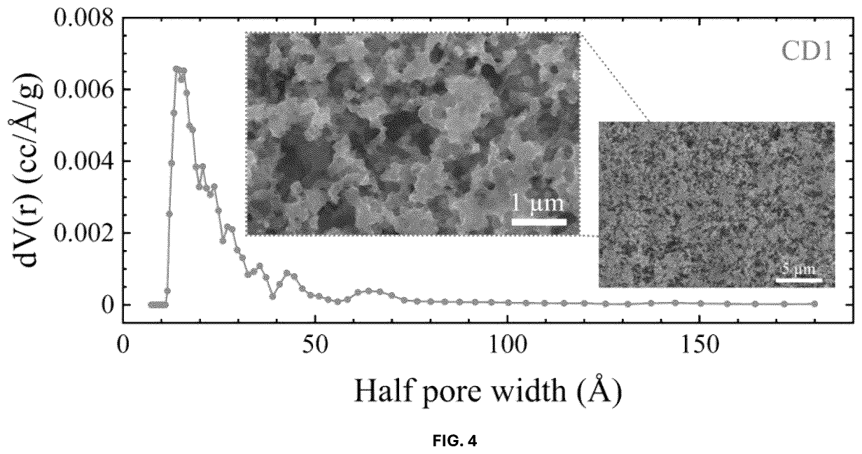

In some embodiments of the present disclosure, the first and second electrodes may be porous or non-porous. For instance, the first electrode may be porous, while the second electrode may be non-porous. Generally, either, or both, of the first and second electrode may be porous or non-porous. Additionally, said porosity may have a distribution within an electrode. For instance, as a non-limiting example, different pore size distributions are shown in FIGS. 4-6. Without wishing to be bound by any particular theory, the inventors of the present disclosure have found that porous electrodes may increase the Seebeck coefficient of the thermoelectrochemical cell when compared to the non-porous electrodes. Additionally, electrodes with pore sizes on the order of solvation shell radius of the ions from the electrolyte may be used. For instance, without wishing to be bound by any particular theory, electrodes having pore sizes on the order of the solvation shell radius of the ions from the electrolyte may increase the Seebeck coefficient of a thermoelectrochemical cell.

In some embodiments of the present disclosure, the porous electrodes may comprise a mesoporous material.

Without wishing to be limited by any particular theory, it is believed that the presently observed voltage oscillations in thermoelectrochemical cells having porous electrodes are caused by unique interactions between the electrolyte and the electrode at the electric double layer. This interaction is tunable based upon several factors, such as the electrode material, porosity of said electrode and electrolyte material.

Thus, the present invention allows for devices needing voltage oscillations. Such devices include, but are not limited to, pacemakers, radio receivers, television sets, radio and television broadcast transmitters, computers and computer peripherals and other systems which may require pulsed power.

The separator of the thermoelectrochemical cell is not particularly limited. For instance, the separator may comprise one commonly used in the art, such as, but not limited to, cellophane, polyolefins, glass-fiber mat, nylons, resins, or other polymers. In some embodiments of the present disclosure, the separator may comprise a natural product. For example, said natural product may comprise cellulose. In embodiments wherein the separator comprises cellulose, the cellulose may be derived from cellulosic sources. In order to obtain a cellulose separator, thin slices may be taken from the cellulosic source. The thin slice taken from the cellulosic source may be taken from any orientation as compared to the grain structure of the cellulosic source. For instance, thin slices may be taken perpendicular or parallel with the grain structure of the cellulosic source. Without wishing to be limited by any particular theory, particular orientation of the cellulose separator may allow for the passage of ions through channels within the cellulose separator.

In some embodiments of the present disclosure wherein the separator comprises cellulose, the thin slices taken from the cellulosic source may be taken at an angle slightly off from perpendicular or parallel, such as greater than 5 degrees off perpendicular or parallel, such as greater than 10 degrees, such as greater 15 degrees, such as greater than 20 degrees. Without wishing to be limited by any particular theory, it is believed that the ease with which ions pass through the separator from the first electrode to the second electrode at least partially depends upon the orientation and the sterics of the pores disposed throughout said separator. Thus, altering the angle at which thin slices are taken from the cellulosic source can be used to alter properties of the thermoelectrochemical cell, such as effective ionic mobility.

In some embodiments, the separator may comprise nafion, aramid, kevlar, other ionically selective membranes based on materials such as polyamides, zeolities, covalent organic frameworks (COFs), metal organic framework (MOFs), 2D materials such as graphene, or derivatives and mixtures thereof. Nafion may be generally described as a sulfonated tetrafluoroethylene based fluoropolymer copolymer.

Generally, various separators as known within the art as being useful for ion exchange may be used. However, various attributes may be considered for potential separators. First, separators used within the thermoelectrochemical cell as described herein may be poor thermal conductors, so as to maximize the thermal gradient across the hot and cold side of the housing. Further, it should be a poor electronic conductor, be wettable by the electrolyte, and have pores which may allow for the transmission of ions from one side of the thermoelectrochemical cell to another.

In some embodiments of the present disclosure, the electrolyte material may comprise an aqueous solution which comprises an electrolyte. For instance, in some embodiments, the electrolyte solution comprises positively charged ions which include, but are not limited to, lithium, sodium, potassium, calcium, magnesium, zinc or combinations thereof. Additionally, the electrolyte may comprise negatively charged ions which include, but are not limited to, chloride, chlorite, chlorate, perchlorate, phosphate, phosphite, bicarbonate. While the previously listed cations and anions are inorganic in nature, organic electrolytes may also be used. For instance, various salts of ammonium may be used, such as, but not limited to, TEABF₄. Generally, however, the electrolyte may be present in the aqueous solution at a concentration 1 vol. % to 20 vol. %, such as 1.5 vol. % to 15 vol. %, such as 2 vol. % to 7 vol. %, such as 2 vol. % to 5 vol. %. In some embodiments, the electrolyte may be present in the aqueous solution at a concentration of 1 vol. % to 8 vol. %.

In some embodiments of the present disclosure, the thermoelectrochemical cells described herein may comprise non-aqueous solvents. For instance, various solvents including, but not limited to, ethers, esters, carbonates or nitriles may be used. For instance, in some embodiments of the present disclosure, acetonitrile may be used. However, one of skill in the art will appreciate that choice in solvent and electrolyte depends on a variety of factors, such as its wettability with respect to the separator and electrode. Additionally, for the purposes of thermoelectrochemical cells as described herein, it is useful if the constituent ions in an electrolyte will segregate under a thermal gradient.

As stated, the present disclosure may be useful for powering a variety of devices. Some devices which may be powered by the thermoelectrochemical cell of the present disclosure include the devices listed in the Background section herein. However, the devices which may be used in concert with the presently described thermoelectrochemical cell are not limited to only wearable devices, or microsensors. Rather, the thermoelectrochemical cell of the present disclosure merely enables their continuous use as compared to what exists within the art.

In some embodiments of the present disclosure, the thermoelectrochemical cell may be used as a means to harvest power. As described within the Background of the specification, two thirds of energy, when converted from a primary type such as chemical energy to a secondary type such as electrical, is lost to heat. Thus, the thermoelectrochemical cell of the present disclosure may be used in various settings to harvest heat which would otherwise go to waste.

In some embodiments, the present disclosure may be adapted to be used to generate electricity from sources not used for energy conversion. For instance, the sun emits high amounts of radiation which warm various surfaces. Thus, one of skill can adapt the housing of the thermoelectrochemical cell in order to capture the difference in temperature between, for instance, the outside of a building and inside of a building.

In some embodiments of the present disclosure, the presently described thermoelectrochemical cell may be used in concert with a battery powered device. For instance, in times wherein the thermoelectrochemical cell is exposed to little thermal gradient, the device may be powered by a battery. However, in times when the thermoelectrochemical cell is exposed to a thermal gradient, the thermoelectrochemical cell may be used to charge the battery or power the device, or a combination thereof. As a non-limiting example, the thermoelectrochemical oscillator may be used in combination with a tire pressure sensor in a vehicle. In times when the vehicle is in operation, the thermal gradient between the heated tires and the ambient air may be sufficient to enable the thermoelectrochemical oscillator to power the pressure sensor, or charge the battery, or both. However, when the vehicle is at rest, the pressure sensor may be powered by the battery, which may have previously been charged by the thermoelectrochemical cell. One of skill in the art will appreciate, however, that said combination of a device, a thermoelectrochemical cell, and a battery is not particularly limited to the instance as described above.

In some embodiments of the present disclosure, the thermoelectrochemical cell may be used in concert with an energy storage device. For instance, said energy storage device may include, but is not limited to, a capacitor, a supercapacitor, a supercapacitor bank or combinations thereof. Generally, one of skill will appreciate that the presently described thermoelectrochemical cell may be used in concert with an energy storage device.

The present invention marks a significant increase in the ability for thermoelectrochemical cells to harvest low grade waste heat. For instance, table 1 below shows various types of electrodes used in thermoelectrochemical cells, and their corresponding Seebeck coefficients, as well as data including the temperature differential said coefficient was measured at, as well as the open circuit voltage.

TABLE 1
Various electrodes and their Seebeck coefficients

| | \|OCV\| | Temperature | Seebeck Coefficient |
|---|---|---|---|
| Electrode | (mV) | difference (K) | (mV K⁻¹) |
| CD1 ^{this work} | 1020 | 10 | 102 |
| CD2 ^{this work} | 780 | 10 | 78 |
| BP^{this work} | 600 | 10 | 60 |
| Carbon | 95 | 5 | 19 |
| Gold | 29.12 | 1.6 | 18.2 |
| Pt | 128.88 | 18 | 7.16 |
| Ag or Hg | 10.44 | 0.4 | 26.1 |
| CNT | 61.05 | 5.5 | 11.1 |
| Pt | 110 | 5.5 | 24 |

### Detailed Description of the Figures

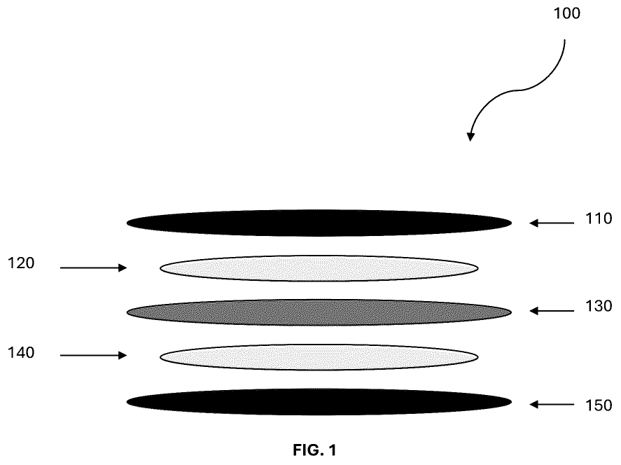

FIG. 1 is a schematic showing the possible assembly of a thermoelectrochemical cell as described herein. For instance, the thermoelectrochemical cell 100 may comprise a housing which comprises housing constituents 110 and 150. As described above, in some embodiments of the present disclosure, either of the housing constituents 110, 150 may be hot or cold. Next, between housing constituents 110, 150 are the first electrode 120 and the second electrode 140. As stated above, in some embodiments, the first electrode 120 may comprise a hot electrode, and the second electrode 140 may comprise a cold electrode. However, in other embodiments of the present disclosure, this ordering may be swapped. Nonetheless, lying between the first and second electrodes 120, 140 is the separator 130. Not pictured in thermoelectrochemical cell 100 is the electrolyte, which is disposed between the first and second electrodes 120, 140.

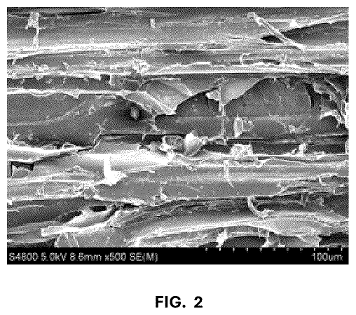

FIG. 2 is an SEM photograph of a cellulose separator taken from a perspective perpendicular to the grain of the cellulose fibers.

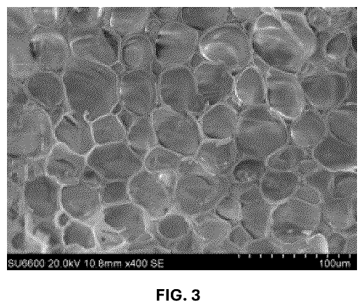

FIG. 3 is an SEM photograph of a cellulose separator taken from a perspective in-line with the grain of the cellulose fibers.

FIG. 4 shows the DFT-based pore size distribution of CD1 electrode. The inset shows an SEM micrograph of the electrode's surface at two different magnifications.

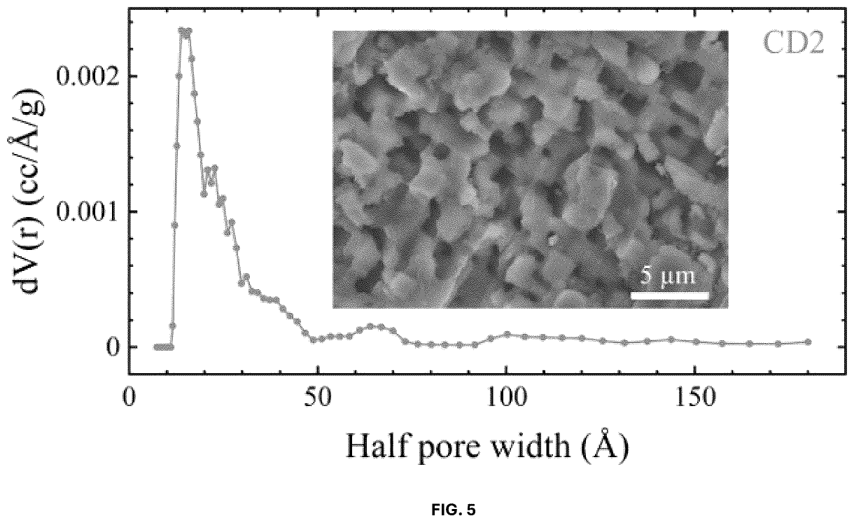

FIG. 5 shows the DFT-based pore size distribution of CD2 electrode. The inset shows an SEM micrograph of the electrode's surface.

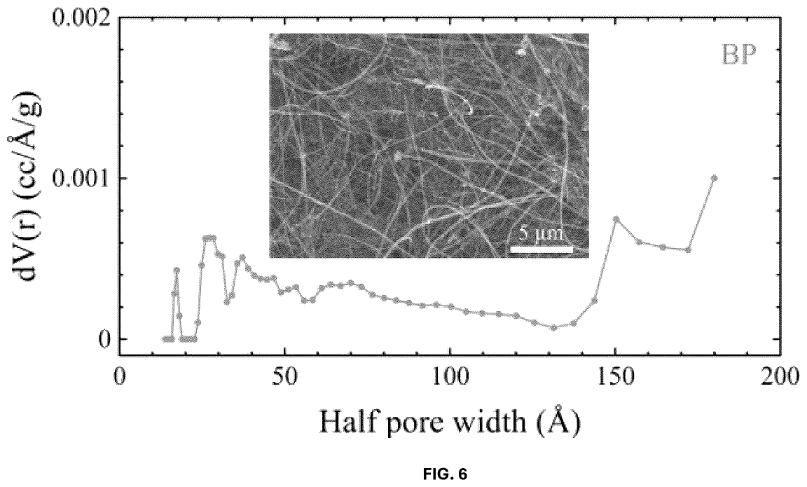

FIG. 6 shows the DFT-based pore size distribution of bucky paper electrode. The inset shows an SEM micrograph of the electrode's surface.

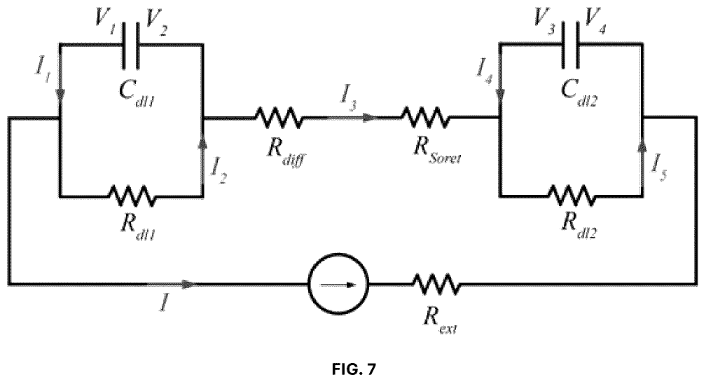

FIG. 7 shows a circuit model equivalent to the thermoelectrochemical cell. R_{diff} refers to the ionic diffusion resistance within the electrolyte, R_{Soret} is the resistance to thermodiffusion within the electrolyte, R_{dl1}, R_{dl2}, C_{dl1}, and C_{dl2} represent double layer resistances and capacitances at the two electrode-electrolyte interfaces, respectively. While Rₑₓₜ is the resistance of the external connections, and/is the discharge current applied during the galvanostatic discharge process of the thermoelectrochemical cell, I₁, I₂, I₄, V₁, V₂, V₃, and V₄ are assumed to vary temporally.

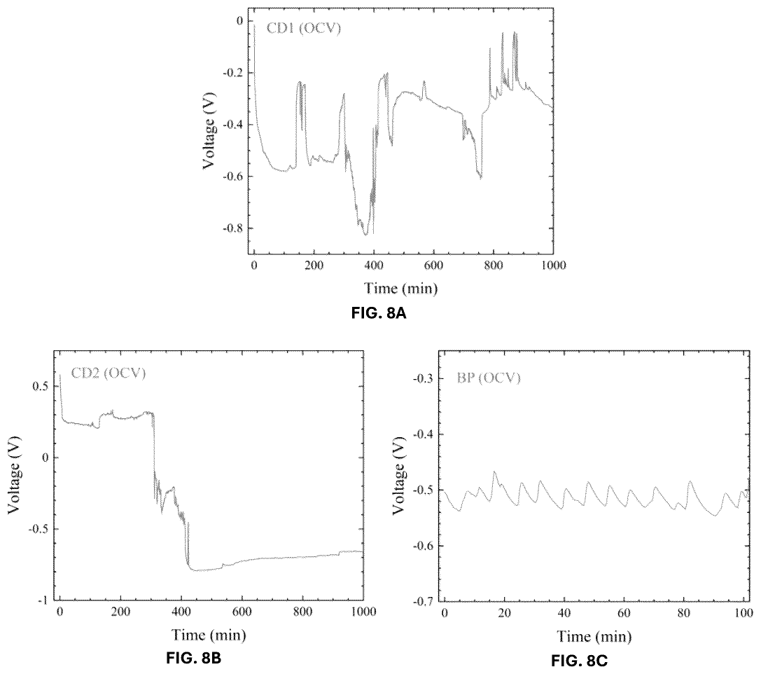

FIG. 8A shows the voltage-time graph of the open circuit voltage for the thermoelectrochemical cell (with a temperature difference of 10 K across the thermoelectrochemical cell) comprising the CD1 type electrodes. The OCV across thermoelectrochemical cell was recorded every 30 s with a Keithley 2400 multimeter which was controlled using Labview.

FIG. 8B shows the voltage-time graph of the open circuit voltage for the thermoelectrochemical cell (with a temperature difference of 10 K across the thermoelectrochemical cell) comprising the CD2 type electrodes. The OCV across thermoelectrochemical cell was recorded every 30 s with a Keithley 2400 multimeter which was controlled using Labview.

FIG. 8C shows the voltage-time graph of the open circuit voltage for the thermoelectrochemical cell (with a temperature difference of 10 K across the thermoelectrochemical cell) comprising the bucky paper type electrodes. The OCV across thermoelectrochemical cell was recorded every 30 s with a Keithley 2400 multimeter which was controlled using Labview. OCV as a function of time for the CD1, CD2 and bucky paper type thermoelectrochemical cells suggests that the OCV and its temporal behavior depend not only on the electrolyte but also on the electrode materials and their porosity.

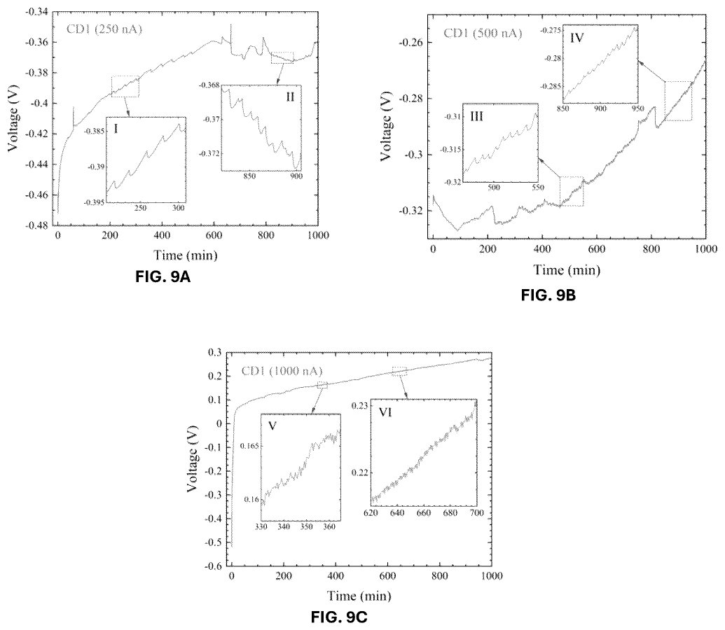

FIG. 9A is a voltage-time graph of a symmetric cell based on CD1 electrodes, cellulose obtained from delignified wood as the separator, and an aqueous electrolyte containing sodium chlorite and polyethylene oxide for a 250 nanoampere discharge current. Applied to the symmetric thermoelectrochemical cell was a temperature difference of 10 Kelvin.

FIG. 9B is a voltage-time graph of a symmetric cell based on CD1 electrodes, cellulose obtained from delignified wood as the separator, and an aqueous electrolyte containing sodium chlorite and polyethylene oxide for a 500 nanoampere discharge current. Applied to the symmetric thermoelectrochemical cell was a temperature difference of 10 Kelvin.

FIG. 9C is a voltage-time graph of a symmetric cell based on CD1 electrodes, cellulose obtained from delignified wood as the separator, and an aqueous electrolyte containing sodium chlorite and polyethylene oxide for a 1000 nanoampere discharge current. Applied to the symmetric thermoelectrochemical cell was a temperature difference of 10 Kelvin.

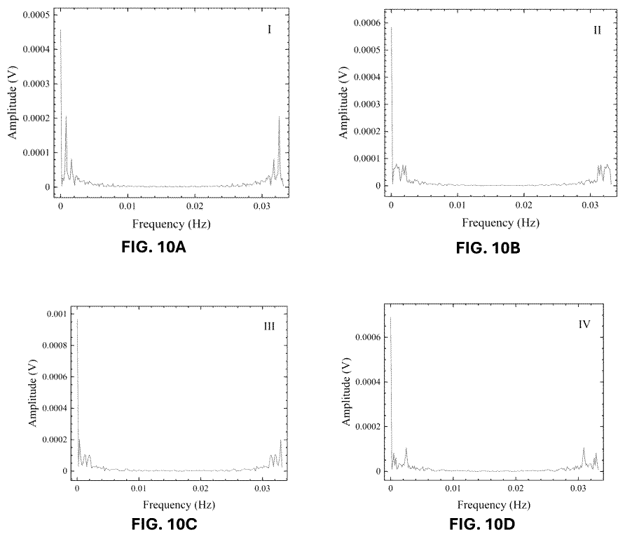

FIGS. 10A-D are fast Fourier transforms of the data taken from insets I-IV in FIGS. 9A-9B.

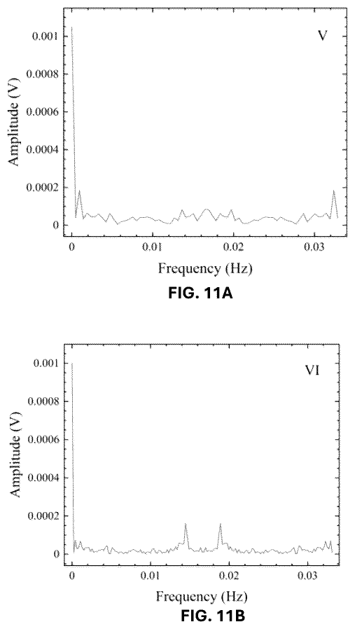

FIGS. 11A-B are fast Fourier transforms of the data taken from insets V-VI in FIG. 9C.

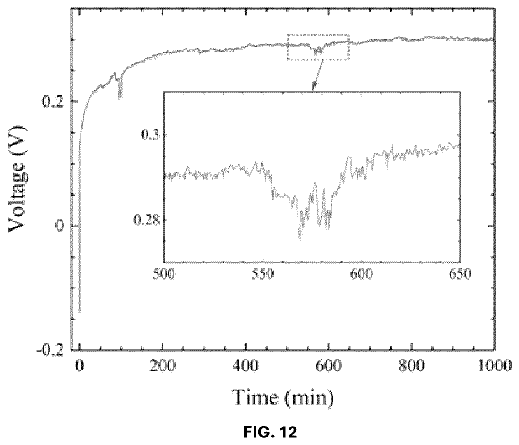

FIG. 12 is a voltage-time graph for a thermoelectrochemical cell with CD1 type electrodes, an aqueous electrolyte comprising sodium chlorite and polyethylene oxide and a cellulose separator at a discharge current of 500 nanoamperes without the application of a thermal gradient during discharge.

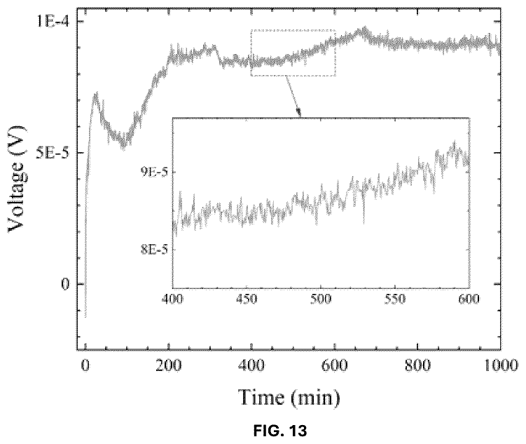

FIG. 13 is a voltage-time graph for a thermoelectrochemical cell with bucky paper electrodes, an electrolyte comprising 1 molar TEABF₄ in acetonitrile and a Celgard polypropylene separator when charged at 100 nanoamperes without the application of any thermal gradient during charge.

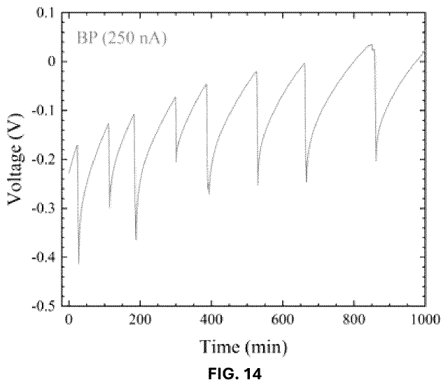

FIG. 14 is a voltage-time graph of a thermoelectrochemical cell comprising bucky paper electrodes, aqueous sodium chlorite and polyethylene oxide as the electrolyte, and a separator of delignified wood comprising the separator being discharged at 250 nanoamperes while maintaining a temperature difference of 10 K across the thermoelectrochemical cell.

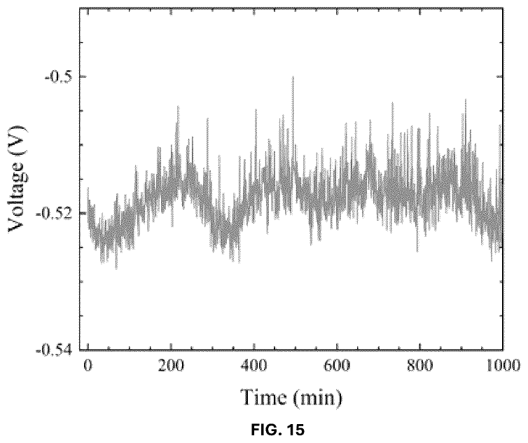

FIG. 15 is a voltage-time graph for a thermoelectrochemical cell with CD2 type electrodes, an aqueous electrolyte comprising sodium chlorite and polyethylene oxide and a cellulose separator at a discharge current of 5 nanoamperes without the application of a thermal gradient during discharge.

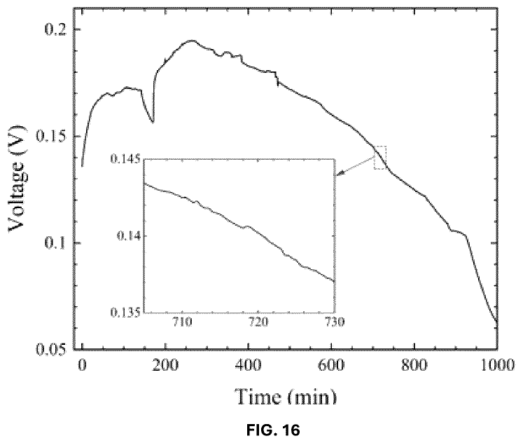

FIG. 16 is a voltage-time graph for a thermoelectrochemical cell comprising non-porous stainless steel electrodes being discharged at 5 nanoamperes.

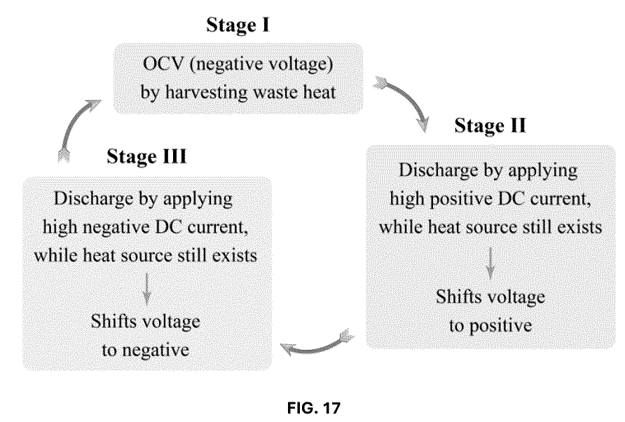

FIG. 17 is a scheme showing a potential method for using the presently described thermoelectrochemical oscillator in continuous operation.

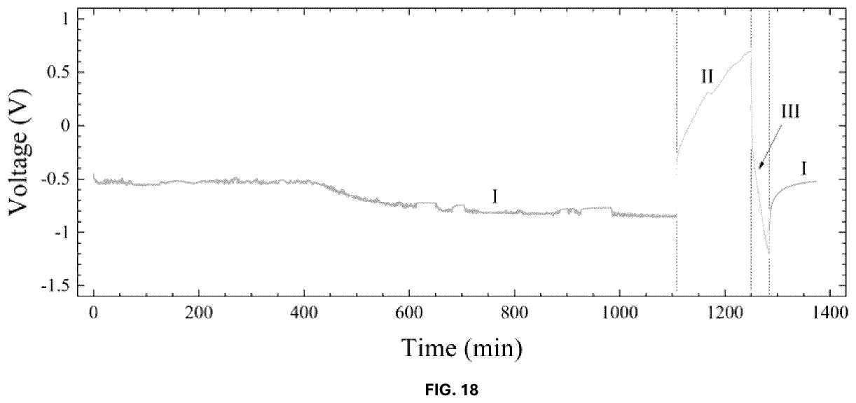

FIG. 18 is a voltage-time graph showing the output voltages when operated according to the scheme shown in FIG. 17. Further, FIG. 18 contains distinct voltage, domains, each corresponding to a phase depicted in FIG. 17.

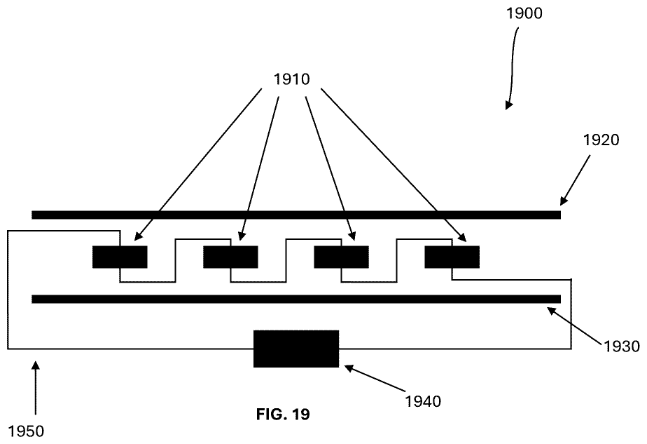

FIG. 19 is a schematic of four thermoelectrochemical cells 1910 wired in series. The four thermoelectrochemical cells 1910 are sandwiched between a hot material 1920 and a cold material 1930. Both of the hot and cold materials 1920, 1930 are thermally conductive and electrically insulative. Thus, the four thermoelectrochemical cells 1910 are in series electrically and in parallel thermally. Wires 1950 connect the four thermoelectrochemical cells 1910 to electronic device 1940.

The present invention may be better understood with reference to the examples, set forth below.

### Example

### Delignification Process for Cellulose Separators

Balsa wood sheets with a thickness of 1.5 mm were purchased from Amazon, USA. The matrix substances, such as lignin and hemicellulose, were removed following the procedure reported in our previous work. The wood pieces were boiled in a 2% sodium chlorite solution buffered with acetic acid at pH 4.6. The solution was changed every 6 hours, and the reaction was continued until white delignified wood (DW) was attained. The DW pieces were washed thoroughly with DI water and freeze-dried using a FreeZone freeze-dry system (Labconco, MO, USA). The scanning electron micrographs of the cellulosic separator obtained from DW are shown in FIGS. 2 and 3.

### Coin Cell Preparation

The cellulosic separator obtained from DW was further treated before being used in our coin cells. It was soaked overnight in an aqueous solution of 0.28 M sodium chlorite containing 20 wt. % polyethylene oxide. Symmetric coin cells were fabricated using three types of porous electrodes: (i) Bucky Paper (60 g m⁻²) made from multi-walled carbon nanotubes (MWCNTs) purchased from NanoTechLabs (NC, USA), (ii) high-porosity aluminum foil #071375 (type CD1), and (iii) low-porosity aluminum foil #140012 (type CD2). Both CD1 and CD2 anodized aluminum oxide (AAO) foils were obtained from Cornell Dubilier Electronics (SC, USA).

### Thermoelectrochemical Module Fabrication

A module was fabricated comprising four thermoelectrochemical coin cells (20 mm diameter) connected electrically in series but thermally in parallel between two copper heatsinks. A similar arrangement is shown in FIG. 19, wherein the four thermoelectrochemical cells 1910 are in series electrically, and in parallel thermally. Because the heatsinks in the setup must provide ΔT, an electrically insulating layer must be used to connect the cells in series. For this layer, we used pouch-cell metalized polymer film (˜100 mm˜˜100 mm×˜0.1 mm) upon which we placed four conductive pads made from adhesive-backed Cu tape (˜25 mm dia.×0.1 mm thickness) arranged in a square. A second insulating layer with four similarly placed Cu pads was constructed for placement against the opposing heatsink, such that the thermoelectrochemical cells could be sandwiched between matching opposite Cu pads. Electrical connections were made by soldering a polymer-insulated #30 AWG Cu wire to the edge of the Cu pads, providing a series circuit of the four thermoelectrochemical coin cells.

### Characterizations

Fourier-transform infrared spectroscopic analysis was conducted directly on wood sheets (before and after delignification) with a ThermoFisher Nicolet iS50 spectrometer equipped with a diamond ATR. Scanning electron microscopy (SEM) examinations were carried out using a Hitachi SU6600 FE-SEM at 5 kV. Gas physisorption measurements were conducted on porous electrodes using a Quantachrome Autosorb iQ gas sorption analyzer using N₂ gas.

Discussion about FFT Data:

Firstly, a third-order polynomial was fitted to the data presented in the insets I-VI of FIGS. 9A-9C. The data was then subtracted from the third-order polynomial to perform background correction. Next, the minimum point in the data obtained after the previous step was shifted to zero. Henceforth, we refer to this newly obtained data as ‘background corrected data’. Subsequently, a two-sided fast Fourier transform of the ‘background corrected data’ was performed, and the results were normalized. The normalization factor was chosen to be 1/(Sampling interval*number of samples). The normalized results are shown in FIGS. 10A-11B, where the voltage amplitude at 0 Hz represents the average value (DC value) of the ‘background corrected’ time domain data.

Open circuit voltages were obtained for the three different cell types, with Table 2 containing summary data below.

TABLE 2
Summary data for open circuit voltages of three electrode types

| | Electrode type | | | | | |
|---|---|---|---|---|---|---|
| Cell number | CD1 | | CD2 | | BP | |
| 1 | −0.74 | V | −0.79 | V | −0.63 | V |
| 2 | −0.83 | V | −1.11 | V | −0.67 | V |
| 3 | −1.18 | V | −0.79 | V | −0.45 | V |
| 4 | −0.84 | V | −1.26 | V | | |
| 5 | −1.02 | V | −1.06 | V | | |

| | | | |
|---|---|---|---|
| Average +/− S.D. | −0.922 V +/− 0.176 V | −1.002 V +/− 0.207 V | −0.5833 V +/− 0.117 V |

Further, Table 3 shown below shows the open circuit voltage for CD1 type electrodes at varying temperature gradients.

TABLE 3
Summary data for OCV at varying temperature gradients

| Temperature difference (ΔT) | Open circuit voltage (V) | |
|---|---|---|
| 0K | ~0 | V |
| 7.5K | −0.490 | V |
| 10K | −0.84 | V |

With respect to FIGS. 10A-11B, which are based on the insets shown in FIGS. 9A-9C, Table 4 below shows summary of the data regarding the current, frequency range and peak amplitudes.

TABLE 4
Summary data for fast Fourier transform
insets shown in FIGS. 10A-11B.

| | | Frequency | Peak |
|---|---|---|---|
| Current | Time | Range | Amplitudes |
| (nA) | (mins) | (mHz) | (mV) |
| 250-Inset I | 205-310 | 0.79-2.53 | 0.207-0.022 |
| 250-Inset II | 820-905 | 0.779-4.67 | 0.081-0.0169 |
| 500-Inset III | 465-550 | 0.38-4.28 | 0.202-0.032 |
| 500-Inset IV | 850-950 | 0.49-5.97 | 0.084-0.015 |
| 1000-Inset V | 330-365 | 0.93-16.43 | 0.186-0.084 |
| 1000-Inset VI | 620-698 | 1.06-16.34 | 0.16-0.025 |

FIGS. 10A-11B suggests that voltage oscillations in each inset have multiple frequency components (with different phase shifts). While components at certain frequencies have larger amplitudes, there are many frequencies with smaller amplitudes, too. To focus on the dominant frequencies, we looked at the frequencies whose amplitude was at least 10% of the amplitude of the most dominant non-zero frequency.

Table 4 suggests that for all the currents used in this study, the inset taken at an earlier time interval has a larger spread of peak amplitudes in the FFT data. Nonetheless, the frequency spread is larger for the later inset, irrespective of the current. Additionally, the number of peaks is also larger for later insets. Since (a) we have more peaks (or more frequency components) in later insets and (b) the voltage oscillation amplitude is roughly the same (in the time domain), the contribution of individual frequency components to the oscillations will be reduced. This explains the smaller spread of peak amplitudes for later insets. Lastly, fewer peaks in the earlier insets at all the currents imply that ions within larger pores probably start contributing to the oscillations earlier than ions within smaller pores. This is because several smaller pores may be connected to larger pores (as in a hierarchically porous structure wherein micropores and mesopores are present inside macropores).

While, at a fixed current, the frequencies are expected to be characteristic of the material's microporous structure, the complexity of the porous structure (hierarchically porous structure with pores of multiple sizes) leads to different FFT plots for two separate insets at the same current. However, we expect a single dominant frequency for a fixed current for an electrode with a uniform porous structure (with a narrow pore size distribution). Moreover, the frequencies in the range of mHz indicate that the period of oscillation is of the order of several minutes, as can be seen from the time domain data.

### Discharging Thermoelectrochemical Coin Cells Using a Constant Resistance Load

We conducted additional experiments where a thermoelectrochemical cell was charged thermally and then discharged by connecting it across different resistors. During discharge, two conditions were explored (with and without the temperature difference across the two electrodes). We once again observed voltage oscillations during discharge, both with and without the temperature difference across the electrodes. The total energy that was dissipated (and hence the total energy that was harvested and stored in the thermoelectrochemical coin cell) in the resistors (100 kΩ, 75 kΩ, 50 kΩ, 25 kΩ, 10 kΩ, and 1 kΩ), without any temperature difference between the electrodes, was 11.76 mJ (or 3.27 μWh). Thus, the total energy that it stores is equivalent to energy that would be harvested within 2 hours if the harvested power was equal to the average power dissipated in the 100 kΩ resistor. Table 5 shows the energy dissipated and the average power for every resistor.

TABLE 5
Energy and power dissipated in each resistor during
discharge without a temperature difference between the
electrodes for a single thermoelectrochemical cell.

| Resistor (kΩ) | Energy dissipated (mJ) | Average power (μW) |
|---|---|---|
| 100 | 0.4767 | 1.6050 |
| 75 | 0.4993 | 1.5701 |
| 50 | 0.4810 | 1.4064 |
| 25 | 0.3272 | 0.9915 |
| 10 | 7.5449 | 0.1008 |
| 1 | 2.4375 | 0.0098 |
| Total Energy dissipated | 11.7668 mJ or 3.27 μWh | |

While certain embodiments of the disclosed subject matter have been described using specific terms, such description is for illustrative purposes only, and it is to be understood that changes and variations may be made without departing from the spirit or scope of the subject matter.

What is claimed is:

1. A thermoelectrochemical cell comprising:
a housing, wherein the housing comprises a hot side and a cold side;
first and second electrodes, wherein the first and second electrodes comprise porous electrodes;
an electrolyte, wherein the electrolyte is dispersed throughout the cell; and
a separator, wherein the separator is disposed between the first and second electrodes; and
wherein the housing encloses a part of the first and second electrodes, the electrolyte and the separator.

2. The thermoelectrochemical cell of claim 1, wherein the first and second electrodes comprise anodized aluminum.

3. The thermoelectric cell of claim 1, wherein the first and second electrodes comprise bucky paper.

4. The thermoelectrochemical cell of claim 1, wherein the hot side of the housing has a temperature greater than the cold side of the housing by 5 to 10 degrees Celsius.

5. The thermoelectrochemical cell of claim 1, wherein the electrolyte comprises sodium chlorite.

6. The thermoelectrochemical cell of claim 1, wherein the separator comprises a natural product.

7. The thermoelectrochemical cell of claim 6, wherein the natural product comprises cellulose.

8. The thermoelectrochemical cell of claim 5, wherein the electrolyte comprises 2 vol. % to 5 vol. % sodium chlorite.

9. The thermoelectrochemical cell of claim 1, wherein the thermoelectrochemical cell is connected to an energy storage device.

10. The thermoelectrochemical cell of claim 1, wherein the porous first and second electrodes comprise pores having sizes on the order of solvation shell radius.

11. An electric device comprising:
a power source, wherein the power source comprises:
a housing, wherein the housing comprises a hot side and a cold side;
first and second electrodes, wherein the first and second electrodes comprise porous electrodes;
an electrolyte;
a separator, wherein the separator is disposed between the first and second electrodes;
wherein the housing encloses a part of the first and second electrodes, the electrolyte and the separator; and
a load.

12. The electric device of claim 11, wherein the first and second electrodes comprise anodized aluminum.

13. The electric device of claim 11, wherein the first and second electrodes comprise bucky paper.

14. The electric device of claim 11, wherein the hot side of the housing has a temperature greater than the cold side of the housing by 5 to 10 degrees Celsius.

15. The electric device of claim 11, wherein the electrolyte comprises sodium chlorite.

16. The electric device of claim 11, wherein the separator comprises a natural product.

17. The electric device of claim 16, wherein the natural product comprises cellulose.

18. The electric device of claim 15, wherein the electrolyte comprises 2-5 vol. % sodium chlorite.

19. The electric device of claim 11, further comprising an energy storage device.

20. The electric device of claim 11, wherein the porous first and second electrodes comprise pores having sizes on the order of solvation shell radius.
